(19) United States
(12) Patent Application Publication
(10) Pub. No.: US 2023/0196997 A1
(43) Pub. Date: Jun. 22, 2023

(54) LIGHT-EMITTING DRIVE CIRCUIT, DRIVING METHOD THEREOF, AND DISPLAY PANEL

(71) Applicant: Shenzhen China Star Optoelectronics Semiconductor Display Technology Co., Ltd., Shenzhen, Guangdong (CN)

(72) Inventor: Yan LI, Shenzhen, Guangdong (CN)

(73) Assignee: Shenzhen China Star Optoelectronics Semiconductor Display Technology Co., Ltd., Shenzhen, Guangdong (CN)

(21) Appl. No.: 16/981,726

(22) PCT Filed: May 14, 2020
(86) PCT No.: PCT/CN2020/090303

§ 371 Date: Sep. 17, 2020

(30) Foreign Application Priority Data
Apr. 10, 2020 (CN) 202010278702.1

(51) Int. Cl. G09G 3/3233

(52) U.S. Cl. CPC G09G 3/3233; G09G 2300/0842; G09G 2310/08; G09G 2310/0202

(57) ABSTRACT

A light-emitting drive circuit, a driving method thereof, and a display panel are provided. In the light-emitting drive circuit, a first end of the storage capacitor is connected to a first electrode of the first transistor, a control electrode of the drive transistor, and a second electrode of the second transistor, and a second end of the storage capacitor is connected to a second electrode of the first transistor and a second electrode of the drive transistor. A control electrode of the first transistor is connected to the control line.

### FIELD OF INVENTION

The present invention relates to the field of electronic technologies, and more particularly to a light-emitting drive circuit, a driving method thereof, and a display panel.

### BACKGROUND OF INVENTION

At present, in common light-emitting drive circuits, such as a MINI-LED drive circuit, as shown in FIG. 1, a storage capacitor is often used to maintain a gate voltage of a drive transistor (a MOS tube shown in FIG. 1), the drive transistor is often short-circuited and displays poorly. This is because a data voltage contains ripple voltage and causes charge to accumulate on the storage capacitor. When the drive transistor is charged at high and low voltages, charge cannot be completely discharged, and phenomenon of residual charge occurs. The charge accumulation of the storage capacitor will cause a gate-source end of the drive transistor to be broken down, resulting in failure of the drive transistor, causing the light-emitting device to fail to drive normally, and causing poor display.

### Technical Problem

In the common light-emitting drive circuits, because the data voltage contains ripple voltage and causes charge to accumulate on the storage capacitor. When the drive transistor is charged at high and low voltages, charge cannot be completely discharged, and phenomenon of residual charge occurs. The charge accumulation of the storage capacitor will cause the gate-source end of the drive transistor to be broken down, resulting in failure of the drive transistor, causing the light-emitting device to fail to drive normally, and causing poor display.

### SUMMARY OF INVENTION

The present invention provides a light-emitting drive circuit, a driving method thereof, and a display panel. The contents are as follows:

A light-emitting drive circuit comprises a drive transistor, a first transistor, a second transistor, a storage capacitor, a control line, a data line, a scan line, a first voltage line, a second voltage line, and a light emitting device. The control line is configured to introduce a pulse control signal, the first transistor is configured to turn on in response to the pulse control signal, and voltages connected to the first voltage line and the second voltage line are different. A first end of the storage capacitor is connected to a first electrode of the first transistor, a control electrode of the drive transistor, and a second electrode of the second transistor, and a second end of the storage capacitor is connected to a second electrode of the first transistor and a second electrode of the drive transistor. A control electrode of the first transistor is connected to the control line. A first electrode of the drive transistor is connected to the first voltage line, the second electrode of the drive transistor is connected to the second voltage line, and the drive transistor is connected to the light emitting device. A first electrode of the second transistor is connected to the data line, and a control electrode of the second transistor is connected to the scan line.

A display panel comprises a light-emitting drive circuit. The light-emitting drive circuit comprises a drive transistor, a first transistor, a second transistor, a storage capacitor, a control line, a data line, a scan line, a first voltage line, a second voltage line, and a light emitting device. The control line is configured to introduce a pulse control signal, the first transistor is configured to turn on in response to the pulse control signal, and voltages connected to the first voltage line and the second voltage line are different. A first end of the storage capacitor is connected to a first electrode of the first transistor, a control electrode of the drive transistor, and a second electrode of the second transistor, and a second end of the storage capacitor is connected to a second electrode of the first transistor and a second electrode of the drive transistor. A control electrode of the first transistor is connected to the control line. A first electrode of the drive transistor is connected to the first voltage line, the second electrode of the drive transistor is connected to the second voltage line, and the drive transistor is connected to the light emitting device. A first electrode of the second transistor is connected to the data line, and a control electrode of the second transistor is connected to the scan line.

A driving method of a light-emitting drive circuit. The light-emitting drive circuit comprises a drive transistor, a first transistor, a second transistor, a storage capacitor, a control line, a data line, a scan line, a first voltage line, a second voltage line, and a light emitting device. The control line is configured to introduce a pulse control signal, the first transistor is configured to turn on in response to the pulse control signal, and voltages connected to the first voltage line and the second voltage line are different. A first end of the storage capacitor is connected to a first electrode of the first transistor, a control electrode of the drive transistor, and a second electrode of the second transistor, and a second end of the storage capacitor is connected to a second electrode of the first transistor and a second electrode of the drive transistor. A control electrode of the first transistor is connected to the control line. A first electrode of the drive transistor is connected to the first voltage line, the second electrode of the drive transistor is connected to the second voltage line, and the drive transistor is connected to the light emitting device. A first electrode of the second transistor is connected to the data line, and a control electrode of the second transistor is connected to the scan line. The driving method comprises providing a data signal through the data line, providing a scan signal through the scan line to drive the light emitting device to emit light, and providing the pulse control signal through the control line. A step of providing the pulse control signal through the control line comprises raising the pulse control signal to a high potential state during a display gap of an image and turning on the first transistor, and after turning on the first transistor, the pulse control signal drops to a low potential state and turning off the first transistor.

Beneficial Effect:

An embodiment of the present invention adds a first transistor across a storage capacitor of a light-emitting drive circuit. A control line connected to a control electrode of the first transistor is added. The control line introduces a pulse control signal for controlling conduction of the first transistor connected to both ends of the storage capacitor. Therefore, charge accumulated at two ends of the storage capacitor due to ripple voltage can be released, which can effectively prevent a gate-source of a drive transistor from being broken down and causing the drive transistor to fail, thereby ensuring a normal driving of the light emitting device.

### DESCRIPTION OF DRAWINGS

FIG. 1 is an equivalent schematic diagram of a current common light-emitting drive circuit.

FIG. 2 is an equivalent schematic diagram of a light-emitting drive circuit provided by an embodiment of the present invention.

FIG. 3 is an equivalent schematic diagram of a light-emitting drive circuit provided by another embodiment of the present invention.

FIG. 4 is a first timing diagram of a light-emitting drive circuit provided by an embodiment of the present invention.

FIG. 5 is a second timing diagram of a light-emitting drive circuit provided by the embodiment of the present invention.

FIG. 6 is a schematic diagram of a display panel provided by another embodiment of the present invention.

FIG. 7 is a schematic flowchart of a driving method of a light-emitting drive circuit provided by another embodiment of the present invention.

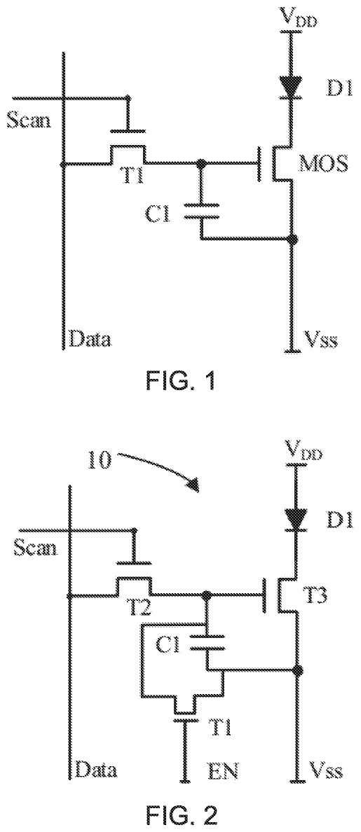

### DETAILED DESCRIPTION OF PREFERRED EMBODIMENTS

In order to make objectives, technical solutions, and advantages of the present invention clearer, the present invention will be further described in detail below with reference to the accompanying drawings and embodiments. Without conflict, the following embodiments and their technical features can be combined with each other. It is understood that the specific embodiments described herein are only used to explain the present invention and are not intended to limit the present invention.

An embodiment of the present invention provides a light-emitting drive circuit. The light-emitting drive circuit comprises a drive transistor, a first transistor, a second transistor, a storage capacitor, a control line, a data line, a scan line, a first voltage line, a second voltage line, and a light emitting device. The control line is configured to introduce a pulse control signal, the first transistor is configured to turn on in response to the pulse control signal, and voltages connected to the first voltage line and the second voltage line are different.

The control line is used to introduce the pulse control signal. A timing chart of the pulse control signal can be seen in FIG. 4. At power-on or at a beginning of each frame, the scan line signal and the data signal line are in a low potential state. The control line signal is raised to a high potential state. The first transistor is turned on in response to the pulse control signal. The charge accumulated on the storage capacitor due to a ripple voltage is discharged, and then the control line signal is lowered to the low potential state. This causes the first transistor to be turned off. After that, the data signal line and the scan signal line are raised to a high potential state to drive the light emitting device to emit light.

Voltages connected to the first voltage line and the second voltage line are different. There is a voltage difference between the voltage on the first voltage line and the second voltage line. The voltage on the first voltage line may be greater than the voltage on the second voltage line or may be less than the voltage on the second voltage line, which is not specifically limited here.

A first end of the storage capacitor is connected to a first electrode of the first transistor, a control electrode of the drive transistor, and a second electrode of the second transistor, and a second end of the storage capacitor is connected to a second electrode of the first transistor and a second electrode of the drive transistor. A control electrode of the first transistor is connected to the control line. A first electrode of the drive transistor is connected to the first voltage line, the second electrode of the drive transistor is connected to the second voltage line, and the drive transistor is connected to the light emitting device. A first electrode of the second transistor is connected to the data line, and a control electrode of the second transistor is connected to the scan line.

The drive transistor is connected to the light emitting device, and the light emitting device may be connected to the first electrode of the drive transistor or the second electrode of the drive transistor, which is not specifically limited here. In this embodiment, the first electrode of the drive transistor may be a drain, and the second electrode of the drive transistor may be a source. The first electrode of the first transistor and the first electrode of the second transistor may be a source or a drain, and the second electrode thereof may also be a drain or a source, which is not specifically limited here.

In this embodiment, a transistor is added across the storage capacitor of the light-emitting drive circuit, and a control line connected to a control electrode of the transistor is added. The control line introduces a pulse control signal. The pulse control signal is raised to a high potential state when the light-emitting drive circuit is turned on or at the beginning of each frame of image display to turn on the first transistor. Therefore, the two ends of the storage capacitor are connected to release the charge accumulated in the storage capacitor due to the ripple voltage. After the charge on both ends of the storage capacitor is released, the control line signal drops to a low potential state to turn off the first transistor. The scan signal and the data signal are raised to a high potential state to drive the light emitting device to emit light through the circuit. In this way, the drive transistor can be effectively prevented from breakdown and failure, and a normal driving of the light emitting device can be ensured.

The present invention also provides another embodiment, referring to FIG. 2, which is an equivalent schematic diagram of the light emitting drive circuit 10 provided by this embodiment. The light-emitting drive circuit 10 includes a drive transistor T3, a first transistor T1, a second transistor T2, a storage capacitor C1, a control line EN, a data line Data, a scan line Scan, a first voltage line, a second voltage line, and a light emitting device D1. The control line EN is configured to introduce a pulse control signal, the first transistor is configured to turn on in response to the pulse control signal, and voltages connected to the first voltage line and the second voltage line are different.

The light-emitting device D1 may be a light-emitting diode, an organic light-emitting diode, or a Mini-LED, which is not specifically limited here. When the light emitting device D1 is a Mini-LED, the Mini-LED has high contrast, high color rendering, and low cost, and has huge technical advantages. In addition, the drive transistor T3 is a field effect transistor, and the first transistor T1 and the second transistor T2 are thin film transistors. When the drive transistor T3 in the light-emitting drive circuit 10 is a field effect transistor (MOS tube), the light-emitting drive circuit 10 is more effective in preventing a gate-source of the drive transistor T3 from being broken down.

The control line EN is configured to introduce a pulse control signal. For a pulse control signal diagram, see FIG. 4. At power-on or at the beginning of each frame, the scan line Scan signal and data line Data signal are in a low potential state. The control line EN signal is raised to a high potential state. The first transistor T1 is turned on in response to the pulse control signal to discharge the charge accumulated on the storage capacitor C1 due to the ripple voltage. After that, the control line EN signal is lowered to a low potential state, so that the first transistor T1 is turned off. After that, the data line Data line and the scan line Scan signal are raised to a high potential state, driving the light emitting device D1 to emit light.

The voltages connected to the first voltage line and the second voltage line are different. There is a voltage difference between the voltage on the first voltage line and the second voltage line. The first voltage line is a VDD (constant voltage high level) voltage line, and the second voltage line is a VSS (constant voltage low level) voltage line.

A first end of the storage capacitor C1 is connected to a first electrode of the first transistor T1, a control electrode of the drive transistor T3, and a second electrode of the second transistor T2, and a second end of the storage capacitor C1 is connected to a second electrode of the first transistor T1 and a second electrode of the drive transistor T3. A control electrode of the first transistor T1 is connected to the control line EN. A first electrode of the drive transistor T3 is connected to the first voltage line, the second electrode of the drive transistor T3 is connected to the second voltage line, and the drive transistor T3 is connected to the light emitting device D1. A first electrode of the second transistor T2 is connected to the data line Data, and a control electrode of the second transistor T2 is connected to the scan line Scan.

In this embodiment, the drive transistor T3 is connected to the light emitting device D1. An anode of the light emitting device D1 is connected to the first voltage line to access a constant voltage high level. A cathode of the light emitting device D1 is connected to a first electrode of the drive transistor T3. A second electrode of the drive transistor T3 is connected to the second voltage line to access a constant voltage low level. In this embodiment, the first electrode of the drive transistor T3 is a drain, and the second electrode of the drive transistor T3 is a source. The first electrode of the first transistor T1 and the first electrode of the second transistor T2 may be a source or a drain, and the second electrode thereof may also be a drain or a source, which is not specifically limited here.

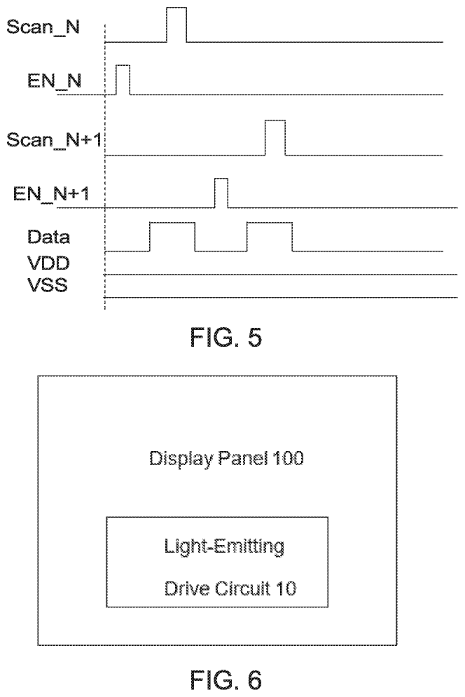

Referring to FIG. 4, which is a timing diagram of the drive circuit in this embodiment. With reference to FIG. 2, at the beginning of each frame or at power-on, the control line EN rises to a high potential signal to turn on the first transistor T1. Therefore, two ends of the storage capacitor C1 are connected, and the charge accumulated on the storage capacitor C1 due to the ripple voltage is discharged. After the charge across the storage capacitor C1 is released, the control line EN signal drops to a low potential to turn off the first transistor T1. After the first transistor T1 is turned off, the data line Data signal and the scan line Scan signal rise to high potential signals. At this time, the second transistor T2 is turned on, the data line Data line charges the storage capacitor C1, and the drive transistor T3 is turned on to drive the light emitting device D1 to emit light. At an initial stage of a next frame, the control line EN is raised to a high potential signal again to turn on the first transistor T1 and release the charge accumulated on the storage capacitor C1. Referring to FIG. 5, this is a timing diagram of the drive circuit of upstream and downstream light emitting devices D1 at the same time in this embodiment. The data signals of upstream and downstream data lines are the same. The control line EN signal of each row is raised to a high potential signal before the data line Data and scan line Scan signals of the current row are raised. The first transistor T1 is turned on to release the charge accumulated on the storage capacitor C1.

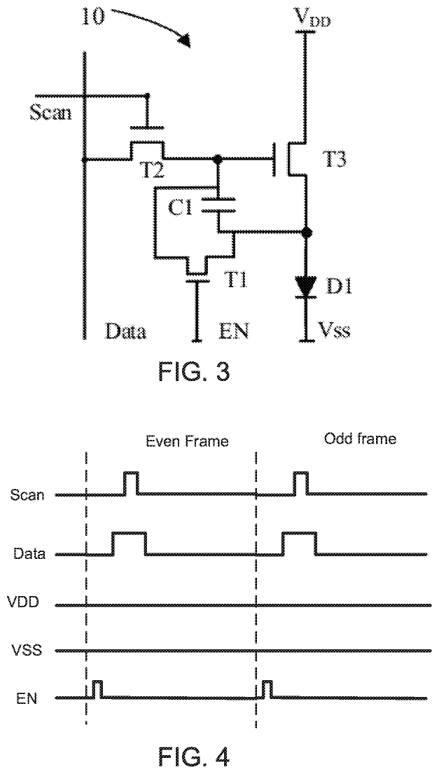

The present invention also provides another embodiment to provide a light-emitting drive circuit. Referring to FIG. 3, in this embodiment, the difference from the above embodiment is that the cathode of the light emitting device D1 is connected to the second voltage line VSS voltage line to access a constant voltage low level. The anode of the light emitting device D1 is connected to the second electrode of the drive transistor T3. The first electrode of the drive transistor T3 is directly connected to the first voltage line VDD voltage line to access the constant voltage high level. The first transistor T1, the drive transistor T3, and the second transistor T2 are thin film transistors.

The timing diagram of the drive circuit in this embodiment can be referred to FIG. 4 and FIG. 5, and its working principle is the same as that of the above embodiment and will not be repeated here.

An embodiment of the present invention also provides a display panel. Referring to FIG. 6, the display panel 100 includes a light-emitting drive circuit 10. The light-emitting drive circuit is the same or similar structure or function as the light-emitting drive circuit 10 in the above embodiment. This enables the light-emitting drive circuit in the display panel 100 to effectively prevent the drive transistor from being broken down and ineffective. The display panel may be a Mini-LED display panel. Therefore, the display panel can avoid a defect that the drive transistor is broken down and becomes invalid, and the display cannot be performed normally.

An embodiment of the present invention also provides a display device. The display device may include the display panel in the foregoing embodiments or one or more light-emitting drive circuits provided in the foregoing embodiments. It is understood that, the display device may also be a combination of a backlight module including one or more light-emitting drive circuits provided in the foregoing embodiments and the display panel in the foregoing embodiments. In addition, it is worth noting that the display panel in the above embodiments may be a Mini-LED display panel or an LCD display panel, etc., which is not specifically limited herein. A backlight module includes one or more light-emitting drive circuits provided in the foregoing embodiments. It is understood that, it can also be a Mini-LED backlight module or an LCD backlight module, etc., which is not specifically limited here.

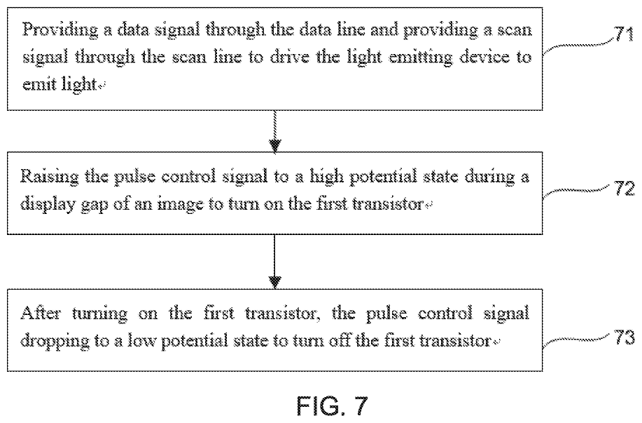

An embodiment of the present invention also provides a driving method of a light-emitting drive circuit. The driving method is suitable for a light-emitting drive circuit. The light-emitting drive circuit of this embodiment is the same or similar in structure or function as the light-emitting drive circuit 10 provided in the above-mentioned embodiment and refer to FIGS. 2 to 7. As shown in FIG. 7, the driving method specifically includes:

Step 71: providing a data signal through the data line, providing a scan signal through the scan line to drive the light emitting device to emit light, and providing the pulse control signal through the control line.

Referring to FIG. 2 or FIG. 3, the data signal provided through the data line Data may be that the data line Data is connected to the first electrode of the second transistor T2. Therefore, the data signal on the data line Data is connected to the light-emitting drive circuit. The scan signal provided through the scan line Scan may be connected to the control electrode of the second transistor T2 through the scan line Scan. The scan signal on the scan line Scan is connected to the light-emitting drive circuit, so that the light emitting device in the drive circuit starts to emit light.

Providing the pulse control signal through the control line includes step 72 and step 73.

Step 72: raising the pulse control signal to a high potential state during a display gap of an image and turning on the first transistor.

Referring to FIG. 4, the pulse control signal rises to a high potential state during the display gap of the image. The display gap may be when the light-emitting drive circuit is turned on, or before a preset time node of each frame image display period and before the high potential state of the data signal and the scan signal. The light-emitting drive circuit has not yet started displaying images when it is turned on. After the pulse control signal is raised to a high potential, it will turn on the first transistor T1 connected to both ends of the storage capacitor C1, and connect the two ends of the storage capacitor C1 to release the charge accumulated on the storage capacitor C1 due to the ripple voltage.

Step 73: after turning on the first transistor, the pulse control signal drops to a low potential state and turning off the first transistor.

Referring to FIG. 4, after the first transistor T1 is turned on to release the charge on the storage capacitor C1, the pulse control signal introduced by the control line EN drops to a low potential state. This causes the first transistor T1 to be turned off, and the two ends of the storage capacitor C1 are disconnected. This time the charge release process across the storage capacitor C1 ends.

In this embodiment, by using the control line EN to introduce a pulse control signal, the pulse control signal is raised to a high potential in the display gap of the image, and the first transistor T1 is controlled to be turned on in the display gap to release the accumulation charge on two ends of the storage capacitor C1. After the charge is discharged, the pulse control signal drops to a low potential to turn off the first transistor T1. After that, the data signal and the scan signal rise to a high potential to turn on the second transistor T2. The storage capacitor C1 is charged and the drive transistor T3 is turned on to drive the light emitting device D1 to emit light. This can avoid failure of the drive transistor T3 and display failure caused by the accumulated charge on the storage capacitor C1 breaking down the drive transistor T3.

Although one or more embodiment was described in this article, a person skilled in the relevant filed may derive some equivalent variants and modifications based on reading and understanding the specification and drawings. This article should comprise all kinds of equivalent variants and modifications. Especially to the functions executed by the above components (such as elements or resources), it is described to execute the mentioned function. In addition, parts of character have been disposed, some other combination or variable changes based on it. Moreover, the terms “include”, “with”, or “have” or its variants, where used in a specification or claim, are designed to have a similar meaning to “comprise”. Further, it is understood that the “plurality” referred to herein refers to two or more. For the steps mentioned in this article, the numerical suffix is only used to clearly describe the embodiment for ease of understanding and does not completely represent the order in which the steps are executed. Thinking should be based on the setting of logical relationships.

The above is only an embodiment of the present invention, and thus does not limit the patent scope of the present invention. Any equivalent structure or equivalent process transformation made by the description and drawings of the present invention, such as the combination of technical features between the embodiments, or direct or indirect application in other related technical fields, are equally included in the patent protection scope of the present invention.

What is claimed is:

1. A light-emitting drive circuit, comprising:
a drive transistor, a first transistor, a second transistor, a storage capacitor, a control line, a data line, a scan line, a first voltage line, a second voltage line, and a light emitting device; wherein the control line is configured to introduce a pulse control signal, the first transistor is configured to turn on in response to the pulse control signal, and voltages connected to the first voltage line and the second voltage line are different;
wherein a first end of the storage capacitor is connected to a first electrode of the first transistor, a control electrode of the drive transistor, and a second electrode of the second transistor, and a second end of the storage capacitor is connected to a second electrode of the first transistor and a second electrode of the drive transistor; a control electrode of the first transistor is connected to the control line; a first electrode of the drive transistor is connected to the first voltage line, the second electrode of the drive transistor is connected to the second voltage line, and the drive transistor is connected to the light emitting device; a first electrode of the second transistor is connected to the data line, and a control electrode of the second transistor is connected to the scan line.

2. The light-emitting drive circuit according to claim 1, wherein the first voltage line is a VDD voltage line, and the second voltage line is a VSS voltage line.

3. The light-emitting drive circuit according to claim 2, wherein an anode of the light emitting device is connected to the first voltage line, and a cathode of the light emitting device is connected to the first electrode of the drive transistor.

4. The light-emitting drive circuit according to claim 2, wherein a cathode of the light emitting device is connected to the second voltage line, and an anode of the light emitting device is connected to the second electrode of the drive transistor.

5. The light-emitting drive circuit according to claim 3, wherein the light emitting device is a light emitting diode.

6. The light-emitting drive circuit according to claim 5, wherein the drive transistor is a field effect transistor, and the first transistor and the second transistor are thin film transistors.

7. The light-emitting drive circuit according to claim 5, wherein the first transistor, the drive transistor, and the second transistor are thin film transistors.

8. A display panel, comprising:
a light-emitting drive circuit, wherein the light-emitting drive circuit comprises:
a drive transistor, a first transistor, a second transistor, a storage capacitor, a control line, a data line, a scan line, a first voltage line, a second voltage line, and a light emitting device; wherein the control line is configured to introduce a pulse control signal, the first transistor is configured to turn on in response to the pulse control signal, and voltages connected to the first voltage line and the second voltage line are different;
wherein a first end of the storage capacitor is connected to a first electrode of the first transistor, a control electrode of the drive transistor, and a second electrode of the second transistor, and a second end of the storage capacitor is connected to a second electrode of the first transistor and a second electrode of the drive transistor; a control electrode of the first transistor is connected to the control line; a first electrode of the drive transistor is connected to the first voltage line, the second electrode of the drive transistor is connected to the second voltage line, and the drive transistor is connected to the light emitting device; a first electrode of the second transistor is connected to the data line, and a control electrode of the second transistor is connected to the scan line.

9. The display pane according to claim 8, wherein the first voltage line is a VDD voltage line, and the second voltage line is a VSS voltage line.

10. The display pane according to claim 9, wherein an anode of the light emitting device is connected to the first voltage line, and a cathode of the light emitting device is connected to the first electrode of the drive transistor.

11. The display pane according to claim 9, wherein a cathode of the light emitting device is connected to the second voltage line, and an anode of the light emitting device is connected to the second electrode of the drive transistor.

12. The display pane according to claim 10, wherein the light emitting device is a light emitting diode.

13. The display pane according to claim 12, wherein the drive transistor is a field effect transistor, and the first transistor and the second transistor are thin film transistors.

14. The display pane according to claim 12, wherein the first transistor, the drive transistor, and the second transistor are thin film transistors.

15. A driving method of a light-emitting drive circuit, wherein the light-emitting drive circuit comprises a drive transistor, a first transistor, a second transistor, a storage capacitor, a control line, a data line, a scan line, a first voltage line, a second voltage line, and a light emitting device; wherein the control line is configured to introduce a pulse control signal, the first transistor is configured to turn on in response to the pulse control signal, and voltages connected to the first voltage line and the second voltage line are different;
wherein a first end of the storage capacitor is connected to a first electrode of the first transistor, a control electrode of the drive transistor, and a second electrode of the second transistor, and a second end of the storage capacitor is connected to a second electrode of the first transistor and a second electrode of the drive transistor; a control electrode of the first transistor is connected to the control line; a first electrode of the drive transistor is connected to the first voltage line, the second electrode of the drive transistor is connected to the second voltage line, and the drive transistor is connected to the light emitting device; a first electrode of the second transistor is connected to the data line, and a control electrode of the second transistor is connected to the scan line;
wherein the driving method comprises:
providing a data signal through the data line, providing a scan signal through the scan line to drive the light emitting device to emit light, and providing the pulse control signal through the control line; wherein a step of providing the pulse control signal through the control line comprises:
raising the pulse control signal to a high potential state during a display gap of an image and turning on the first transistor; and
after turning on the first transistor, the pulse control signal drops to a low potential state and turning off the first transistor.

16. The driving method according to claim 15, wherein the display gap is when the light-emitting drive circuit is turned on; or
the display gap is before a preset time node of each frame image display period and before the high potential state of the data signal and the scan signal.
